(19) United States
(12) Patent Application Publication
(10) Pub. No.: US 2024/0210025 A1
(43) Pub. Date: Jun. 27, 2024

(54) LED light bulb and method of manufacturing the same

(71) Applicant: Qingbiao WU, Fujian (CN)

(72) Inventor: Qingbiao WU, Fujian (CN)

(21) Appl. No.: 18/086,665

(22) Filed: Dec. 22, 2022

(51) Int. Cl. F21V 31/00; F21K 9/232; F21K 9/235; F21K 9/237; F21K 9/90

(52) U.S. Cl. CPC F21V 31/005; F21K 9/232; F21K 9/235; F21K 9/237; F21K 9/90

(57) ABSTRACT

A novel LED light bulb and a manufacturing method thereof, including a light bulb cover, a light bulb cap, a light source component and a power source component; the light bulb cover include a cover body and a mounting part; the mounting part is inserted inside the light bulb cap; a transparent light bulb core is in interference fit with the mounting part; hooks are provided on an end of the transparent light bulb core close to the light bulb cap; the hooks abut an end portion of the mounting part.

### BACKGROUND OF THE INVENTION

The present invention relates to the field of lighting devices, and more particularly a novel LED light bulb and a method of manufacturing the same.

As a result of socio-economic growth and maturing LED technology, LED light bulbs have been more widely used in people's daily life, and LED lighting equipment has been more commonly used in various outdoor occasions, such as outdoor landscape lighting, illumination lighting, large building lighting and so forth.

Conventional LED light bulbs have the problem of poor waterproofing when in use. Particularly, when the LED light bulbs are used outdoor during rainy days, the LED light bulbs after being exposed to rain are prone to malfunction caused by unstable power supply, and may even lead to electrical leakage accidents, thus affecting the reliability, service life and safety of the LED light bulbs.

Based on the above, the present application is produced after conducting in-depth studies on the aforesaid problems.

### BRIEF SUMMARY OF THE INVENTION

It is an object of the present invention to provide a novel LED light bulb with simple structure, lower cost and good waterproofness.

To attain the above object, the present invention provides the following technical solutions: a novel LED light bulb, comprising a light bulb cover, a light bulb cap, and a light source component and a power source component provided inside the light bulb cover and electrically connected to each other; the light bulb cover comprises a cover body and a mounting part integrally connected to the cover body; the mounting part is inserted into the light bulb cap; a transparent light bulb core is in interference fit with the mounting part; through holes are provided on the transparent light bulb core; the power source component passes through the through holes; the through holes penetrate the transparent light bulb core from one side of the transparent light bulb core to another side of the transparent light bulb core; hooks are provided on an end of the transparent light bulb core proximal to the light bulb cap; the hooks hook onto an end of the mounting part.

Preferably, the transparent light bulb core is cylindrical; a diameter of the transparent light bulb core gradually decreases along a direction away from the light bulb cap; the transparent light bulb core is press-fitted with the mounting part.

Preferably, an accommodating space in which glue is filled in is provided between the transparent light bulb core and the end of the mounting part.

Preferably, the power source component comprises a first wire, a second wire, and a power board fitted with the transparent light bulb core; a stepped portion is provided inside the transparent light bulb core; the power board is placed on the stepped portion.

Preferably, the first wire comprises a first power-supplying end configured to be connected with a power source, and a first connecting end connected to the light source component; the second wire comprises a second power-supplying end configured to be connected to the power source, and a second connecting end connected to the light source component.

Preferably, the light source component comprises a LED filament; two ends of the LED filament are electrically connected to the first connecting end and the second connecting end respectively through the power board.

Preferably, the light source component comprises a LED filament; two ends of the LED filament are electrically connected to the power board through rigid conductive wires, and the first connecting end and the second connecting end are electrically connected to the power board respectively.

Preferably, the light bulb cap is provided with internal screw threads; external screw threads corresponding to the internal screw threads are formed on the mounting part.

Preferably, the light bulb cover is made of light-pervious plastic material.

By adopting the aforementioned technical solutions, the beneficial effects of the present invention are as follows:
1. The hooks hook onto the end of the mounting part, which strengthen the connection between the transparent light bulb core and the mounting part, thus improving the waterproof capacity of the light bulb;
2. The transparent light bulb core made of soft plastic material is in interference fit with the mounting part, and is press-fitted into the mounting part of the light bulb cover, which forms good leak-tightness between the transparent light bulb core and the light bulb cover, thereby enhancing waterproofness of the light source component inside the light bulb cover, and effectively improving the waterproof capacity of the LED light bulb;
3. The accommodating space for the glue to fill in is provided between the transparent light bulb core and the end of the mounting part, which forms leak-tightness between the transparent light bulb core and the mounting part, thereby providing good waterproofness, and effectively improving the waterproof capacity of the light bulb.
4. The space between an inner side wall of the mounting part and an outer side wall of the transparent light bulb core, and the space between an outer side wall of the mounting part and an inner side wall of the light bulb cap are filled and sealed with the glue respectively, which further improve the waterproof capacity of the light bulb;
5. The external screw threads are provided on the mounting part, which enhance the stability of connection between the light bulb cover and the light bulb cap;
6. The light bulb cover is made of transparent plastic material, which is not easy to break, and can be manufactured by injection molding or blow molding, without the needs to use an open flame, thus enabling better production safety.

It is also an object of the present invention to provide a manufacturing method of a novel LED light bulb with simple structure, lower cost and good waterproofness.

To attain the above object, the present invention provides the following technical solutions:

A manufacturing method of the above novel LED light bulb; comprising the steps of:
S1: heating up transparent plastic material, then obtaining the light bulb cover by injection blow molding with high-speed air pressure;
S2: heating up plastic material, then forming the transparent light bulb core of a desired shape by injection molding;
S3: fitting the first wire and the second wire onto the transparent light bulb core, then arranging the power board to be fitted also on the transparent light bulb core;
S4: connecting the first wire and the second wire with the light source component through the power board by welding;
S5: visually checking whether a surface of the power board is clean, then checking whether tinning of the light source component, the first wire and the second wire is completed; performing lighting tests with a test probe;
S6: inserting the transparent light bulb core obtained after step S5 into the mounting part of the light bulb cover, and press-fitting the transparent light bulb core into the mounting part; wherein the accommodating space is formed between the mounting part and the transparent light bulb core;
S7: aiming the accommodating space and injecting a predetermined amount of the glue into the accommodating space of the mounting part;
S8: bending one end of the first wire so that the said one end of the first wire is attached to the external screw threads of the light bulb cover; passing one end of the second wire through a top part of the light bulb cap, then threading the light bulb cap with the light bulb cover by rotation;
S9: performing tinning on the top part of the light bulb cap;
S10: after drying the glue, visually checking the LED light bulb if there is leakage of the glue, if the light bulb cap is successfully threaded with the light bulb cover, and if there are impurities inside the light bulb cover, then performing lighting tests on the LED light bulb with the testing power supply.

Preferably, in step S2, the hooks, the stepped portion, and the through holes through which the first wire and the second wire pass through are also formed with the transparent light bulb core during formation of the transparent light bulb core; in step S3, arranging the first wire and the second wire to pass through the through holes respectively so as to be fitted with the transparent light bulb core, then arranging the power board to be fitted on the stepped portion of the transparent light bulb core.

Preferably, in step S6, the hooks hook onto the end of the mounting part when the transparent light bulb core obtained after step S5 is inserted and press-fitted into the mounting part of the light bulb cover.

The manufacturing method of the present invention is simpler and lower in costs.

### BRIEF DESCRIPTION OF THE DRAWINGS

FIG. 1 shows a perspective view of the present invention;

FIG. 2 shows a sectional view of the present invention;

FIG. 3 shows an exploded perspective view of the present invention according to one embodiment;

FIG. 4 shows an exploded perspective view of the present invention according to another embodiment.

As illustrated in the figures: 1 denotes the light bulb cover; 11 denotes the cover body; 12 denotes the mounting part; 121 denotes the external screw threads; 122 denotes the accommodating space; 2 denotes the light bulb cap; 21 denotes the internal screw threads; 3 denotes the transparent light bulb core; 31 denotes the hooks 32 denotes the through holes; 33 denotes the stepped portion; 4 denotes the LED filament; 41 denotes the rigid conducting wires; 51 denotes the first wire; 511 denotes the first power-supplying end; 512 denotes the first connecting end; 52 denotes the second wire; 521 denotes the second power-supplying end; 522 denotes the second connecting end; 53 denotes the power board; 6 denotes the glue.

### DETAILED DESCRIPTION OF THE INVENTION

The technical solutions of the embodiments of the present invention are clearly and fully described below with reference to the accompanying drawings. It is obviously that the embodiments described herein are only some, but not all embodiments of the present invention. All other embodiments obtained by those skilled in the art based on the embodiments of the present invention without inventive efforts should fall within the protection scope of the present invention.

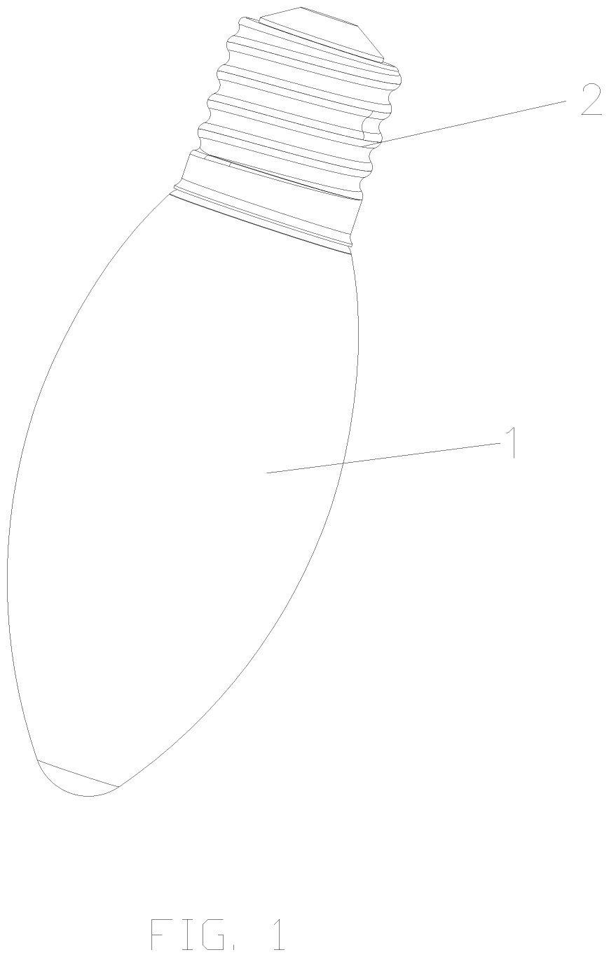

As illustrated in FIGS. 1-4:

The present embodiment provides a novel LED light bulb, comprising a light bulb cover 1, a light bulb cap 2, a transparent light bulb core 3 arranged inside the light bulb cover 1, and a light source component and a power source component provided inside the light bulb cover 1 and electrically connected to each other; the light bulb cover 1 is a light-pervious plastic bulb cover, which enhances the impact resistant capacity of the light bulb and avoids the use of an open flame during manufacturing process; preferably, the light source component is an LED filament 4.

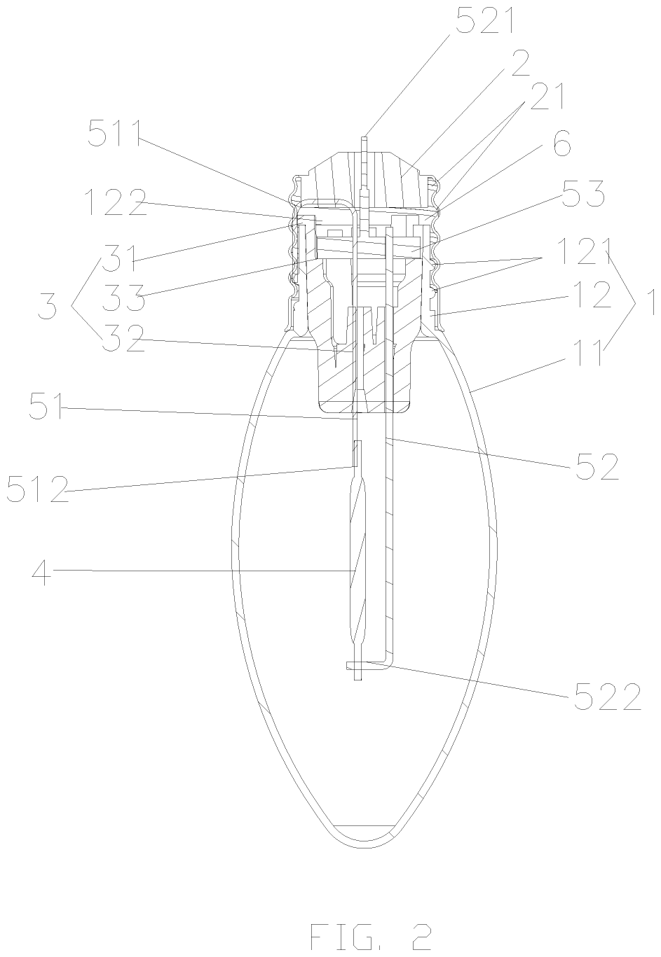

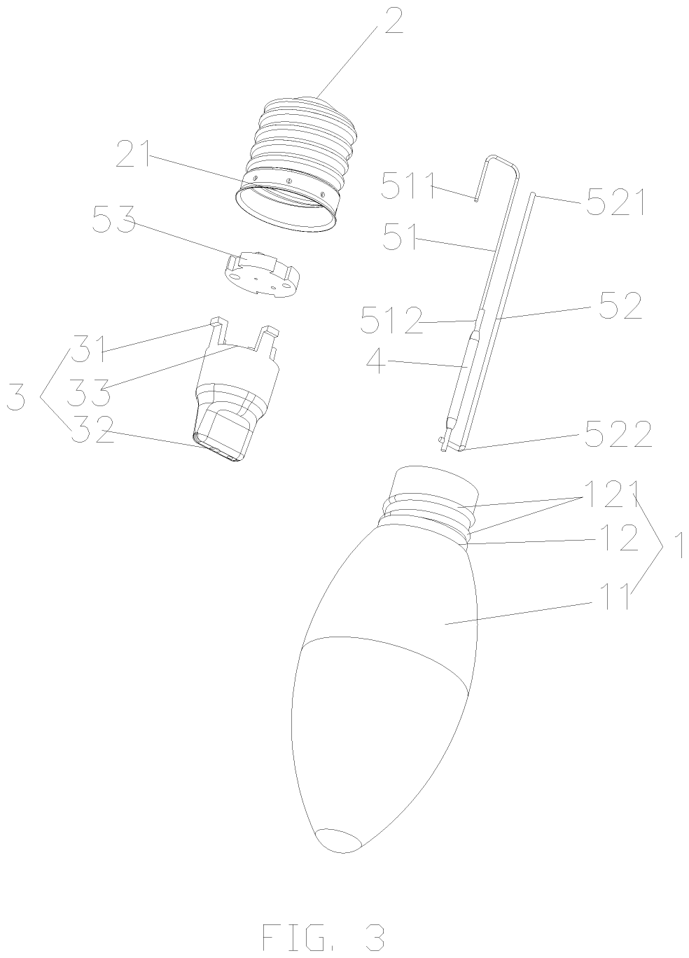

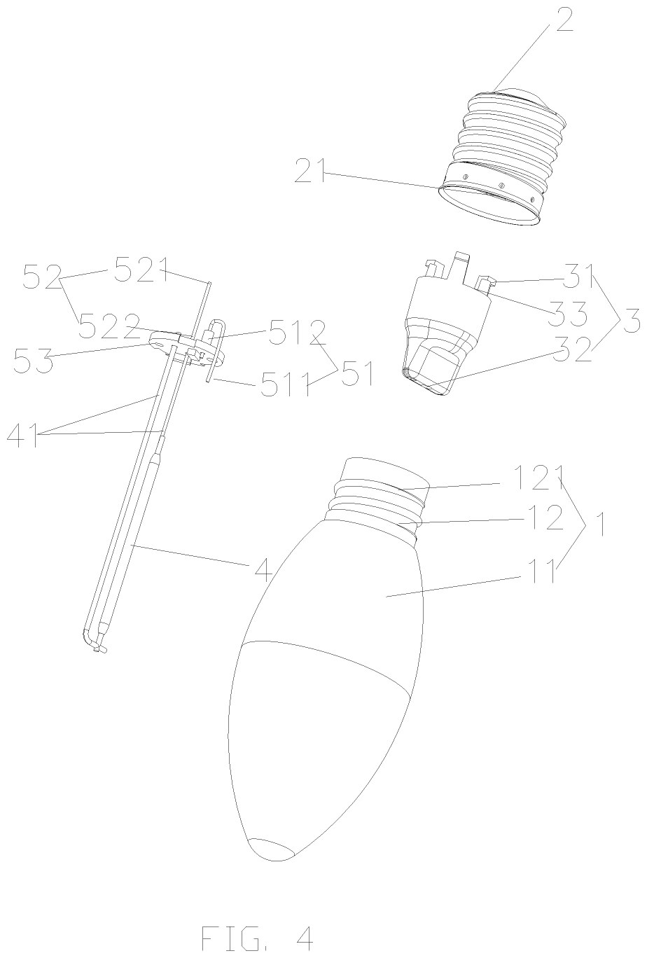

The power source component comprises a first wire 51, a second wire 52, and a power board 53 fitted with the transparent light bulb core 3; the first wire 51 comprises a first power-supplying end 511 connected with a power source, and a first connecting end 512 electrically connected to the power board 53; the second wire 52 comprises a second power-supplying end 521 connected to the power source, and a second connecting end 522 electrically connected to the power board 53 (as illustrated in FIG. 4); the LED filament 4 is electrically connected to the power board 53 through two rigid conducting wires 41; in the present embodiment, the first connecting end 512 and the second connecting end 522 can be directly electrically connected to two ends of the LED filament 4 respectively; or, the first connecting end 512 and the second connecting end 522 can be electrically connected to two ends of the LED filament 4 respectively after passing through the power board 53 (as illustrated in FIGS. 2-3); the different connections mentioned above can be selected according to actual situations, and will not be described in detail herein; it is worth noting that, the first power-supplying end 511 is capable of connecting to a neutral wire of mains electricity, and the second power-supplying end 521 is capable of connecting to a live wire of mains electricity.

The light bulb cover 1 comprises a cover body 11 and a mounting part 12 integrally connected to the cover body 11; the mounting part 12 is inserted into the light bulb cap 2; a part of the light bulb cover 1 not inserted into the light bulb cap 2 (namely the cover body 11) has a shape which is exactly the same as that of a light bulb cover of a conventional tungsten light bulb; specific shape of the cover body 11 can be designed according to actual situations; the transparent light bulb core 3 is in interference fit with the mounting part 12; the transparent light bulb core 3 is a cylindrical light bulb core made of transparent plastic; a diameter of the transparent light bulb core 3 gradually decreases along a direction away from the light bulb cap 2; the interference fit between the transparent light bulb core 3 and the mounting part 12 provides good leak-tightness between the transparent light bulb core 3 and the light bulb cover 1, thereby enhancing waterproofness of the LED filament 4 and the power board 53 inside the cover body 11, and effectively improving the waterproof capacity of the light bulb.

The mounting part 12 is inserted into the light bulb cap 2; the transparent light bulb core 3 is inserted into the mounting part 12; the transparent light bulb core 3 made of transparent plastic material is tightly connected with the mounting part 12 by being pressed into the mounting part, thus achieving the fixed connection between the transparent light bulb core 3 and the mounting part 12; the light bulb core 3 is made of transparent plastic, which improves the heat dissipation capacity of the light bulb, so that heat generated by the power board 53 during operation can be timely dissipated, thereby effectively improving the service life of the light bulb; meanwhile, the transparent light bulb core 3 is fitted into the mounting part 12 by a press-fit operation, which forms good leak-tightness between the transparent light bulb core 3 and the light bulb cover 1, thereby enhancing waterproofness of the LED filament 4 inside the cover body 11, and effectively improving the waterproof capacity of the light bulb; it is worth noting that, the light bulb cap 2 is a threaded cap adopted by conventional tungsten light bulbs, and a main body of which is usually obtained by compression molding with a metal sleeve; therefore, when screw threads are formed on an external part of the light bulb cap 2, internal screw threads 21 are also formed on an internal part of the light bulb cap 2; external screw threads 121 corresponding to the internal screw threads 21 of the light bulb cap 2 are formed on the mounting part 12.

Hooks 31 are provided on an end of the transparent light bulb core 3 proximal to the light bulb cap 2; the hooks 31 hook onto an end of the mounting part 12, which further strengthen the connection between the transparent light bulb core 3 and the mounting part 12, and also improve the waterproof capacity of the light bulb.

Furthermore, an accommodating space 122 for glue 6 to fill in is provided between the transparent light bulb core 3 and the end of the mounting part 12; the accommodating space 122 can be filled with the glue 6, which forms leak-tightness between the transparent light bulb core 3 and the mounting part 12, thereby providing good waterproofness, and effectively improving the waterproof capacity of the light bulb.

Through holes 32 are provided on the transparent light bulb core 3 for the first wire 51 and the second wire 52 to pass through respectively; the through holes 32 penetrate through the transparent light bulb core 3 from one side of the transparent light bulb core 3 to another side of the same; furthermore, a stepped portion 33 is provided inside the transparent light bulb core 3 for the power board 53 to be placed; the power board 53 is placed on the stepped portion 33.

Furthermore, a space between an inner side wall of the mounting part 12 and an outer side wall of the transparent light bulb core 3, and a space between an outer side wall of the mounting part 12 and an inner side wall of the light bulb cap 2 are filled and sealed by the glue 6 respectively, thereby achieving not only more secured connection which prevents the light bulb cover 1 and the light bulb cap 2 from separating from each other under external force during assembly process of the light bulb, but also effectively improving the waterproof capacity of the light bulb.

By adopting the aforementioned technical solutions, the beneficial effects of the present invention are as follows:
1. The hooks 31 hook onto the end of the mounting part 12, which strengthen the connection between the transparent light bulb core 3 and the mounting part 12, thus improving the waterproof capacity of the light bulb;
2. The transparent light bulb core 3 made of soft plastic material is in interference fit with the mounting part 12, and is press-fitted into the mounting part 12 of the light bulb cover 1, which forms good leak-tightness between the transparent light bulb core 3 and the light bulb cover 1, thereby enhancing waterproofness of the light source component inside the light bulb cover 1, and effectively improving the waterproof capacity of the LED light bulb;
3. The accommodating space 122 for the glue 6 to fill in is provided between the transparent light bulb core 3 and the end of the mounting part 12, which forms leak-tightness between the transparent light bulb core 3 and the mounting part 12, thereby providing good waterproofness, and effectively improving the waterproof capacity of the light bulb.
4. The space between an inner side wall of the mounting part 12 and an outer side wall of the transparent light bulb core 3, and the space between an outer side wall of the mounting part 12 and an inner side wall of the light bulb cap 2 are filled and sealed with the glue 6 respectively, which further improve the waterproof capacity of the light bulb;
5. The external screw threads 121 are provided on the mounting part 12, which enhance the stability of connection between the light bulb cover 1 and the light bulb cap 2;
6. The light bulb cover 1 is made of transparent plastic material, which is not easy to break, and can be manufactured by injection molding or blow molding, without the needs to use an open flame, thus enabling better production safety.

A manufacturing method of the aforementioned novel LED light bulb is also provided according to an embodiment of the present invention; the manufacturing method comprises the following steps:
S1: heating up transparent plastic material with an industrial injection blowing machine, then injecting the transparent plastic material into a mold of the light bulb; obtaining the light bulb cover 1 by injection blow molding with high-speed air pressure;
S2: heating up plastic material with an industrial injection molding machine, then injecting the plastic material into a mold of the transparent light bulb core 3 to form the transparent light bulb core 3; the transparent light bulb core 3 is also formed with the hooks 31, the stepped portion 33, and the through holes 32 for the first wire 51 and the second wire 52 or the two rigid conducting wires 41 to pass through respectively;
S3: arranging the first wire 51 and the second wire 52 to pass through the through holes 32 respectively so as to be fitted with the transparent light bulb core 3, then arranging the power board 53 to be fitted on the stepped portion 33 of the transparent light bulb core 3;
S4: connecting the first connecting end 512 of the first wire 51 and the second connecting end 522 of the second wire 52 with the power board 53 by welding; connecting first ends of both the two rigid conducting wires 41 with two ends of the LED filament 4 respectively by welding, and connecting second ends of both the two rigid conducting wires 41 with the power board 53;
S5: visually checking whether a surface of the power board 53 is clean, then checking whether tinning of the LED filament 4, the first wire 51 and the second wire 52 is completed; performing lighting tests with a test probe and a testing power supply;
S6: inserting the transparent light bulb core 3 obtained after step S5 into the mounting part 12 of the light bulb cover 1, and press-fitting the transparent light bulb core 3 into the mounting part 12; hooking the hooks 31 onto the end of the mounting part 12; wherein the accommodating space 122 is formed between the mounting part 12 and the transparent light bulb core 3;
S7: placing the light bulb cover 1 on a working desk; mechanically aiming and injecting a predetermined amount of the glue 6 into the accommodating space 122 of the mounting part 12;
S8: bending the first power-supplying end 511 so that the first power-supplying end 511 is attached to the external screw threads of the light bulb cover 1; passing the second power-supplying end 521 through a welding plate hole on a top part of the light bulb cap 2, then threading the light bulb cap 2 with the light bulb cover 1 by rotation;
S9: performing tinning on the welding plate hole on the top part of the light bulb cap 2; perform tinning on a welding spot of the welding plate hole with an electric soldering iron; wherein the welding spot is required to be arc-shaped, with a smooth surface and no burrs;
S10: after drying the glue 6, visually checking the LED light bulb if there is leakage of the glue 6, if the light bulb cap 2 is successfully threaded with the light bulb cover 1, and if there are impurities inside the light bulb cover 1, then performing lighting tests on the LED light bulb with the testing power supply.

By adopting the aforementioned technical solutions, the manufacturing method of the present invention is simpler and lower in cost.

Although embodiments of the present invention are shown and described herein, it should be understood by those skilled in the art that, various changes, modifications, substitutions and variations without departing from the essence of the present invention, shall also fall within the protection scope of the present invention as defined by the appended claims and the equivalents thereof.

What is claimed is:

1. A LED light bulb, comprising a light bulb cover, a light bulb cap, and a light source component and a power source component provided inside the light bulb cover and electrically connected to each other; the light bulb cover comprises a cover body and a mounting part integrally connected to the cover body; the mounting part is inserted into the light bulb cap; wherein a transparent light bulb core is in interference fit with the mounting part; through holes are provided on the transparent light bulb core; the power source component passes through the through holes; the through holes penetrate the transparent light bulb core from one side of the transparent light bulb core to another side of the transparent light bulb core; hooks are provided on an end of the transparent light bulb core proximal to the light bulb cap; the hooks hook onto an end of the mounting part.

2. The LED light bulb of claim 1, wherein the transparent light bulb core is cylindrical; a diameter of the transparent light bulb core gradually decreases along a direction away from the light bulb cap; the transparent light bulb core is press-fitted with the mounting part.

3. The LED light bulb of claim 1, wherein an accommodating space in which glue is filled in is provided between the transparent light bulb core and the end of the mounting part.

4. The LED light bulb of claim 1, wherein the power source component comprises a first wire, a second wire, and a power board fitted with the transparent light bulb core; a stepped portion is provided inside the transparent light bulb core; the power board is placed on the stepped portion.

5. The LED light bulb of claim 4, wherein the first wire comprises a first power-supplying end configured to be connected with a power source, and a first connecting end connected to the light source component; the second wire comprises a second power-supplying end configured to be connected to the power source, and a second connecting end connected to the light source component.

6. The LED light bulb of claim 5, wherein the light source component comprises a LED filament; two ends of the LED filament are electrically connected to the first connecting end and the second connecting end respectively through the power board.

7. The LED light bulb of claim 5, wherein the light source component comprises a LED filament; two ends of the LED filament are electrically connected to the power board through rigid conductive wires, and the first connecting end and the second connecting end are electrically connected to the power board respectively.

8. The LED light bulb of claim 1, wherein the light bulb cap is provided with internal screw threads; external screw threads corresponding to the internal screw threads are formed on the mounting part.

9. The LED light bulb of claim 1, wherein the light bulb cover is made of light-pervious plastic material.

10. A manufacturing method of the LED light bulb of claim 4; comprising the steps of:
S1: heating up transparent plastic material, and then obtaining the light bulb cover by injection blow molding with high-speed air pressure;
S2: heating up plastic material, then forming the transparent light bulb core into a desired shape by injection molding;
S3: fitting the first wire and the second wire onto the transparent light bulb core, then arranging the power board to be fitted also on the transparent light bulb core;
S4: connecting the first wire and the second wire with the light source component through the power board by welding;
S5: visually checking whether a surface of the power board is clean, then checking whether tinning of the light source component, the first wire and the second wire is completed; performing lighting tests with a test probe;
S6: inserting the transparent light bulb core obtained after step S5 into the mounting part of the light bulb cover, and press-fitting the transparent light bulb core into the mounting part; wherein an accommodating space is formed between the mounting part and the transparent light bulb core;
S7: aiming the accommodating space and injecting a predetermined amount of the glue into the accommodating space of the mounting part;
S8: bending one end of the first wire so that one end of the first wire is attached to external screw threads of the light bulb cover; passing one end of the second wire through a top part of the light bulb cap, then threading the light bulb cap with the light bulb cover by rotation;
S9: performing tinning on the top part of the light bulb cap;
S10: after drying the glue, visually checking the LED light bulb if there is leakage of the glue, if the light bulb cap is successfully threaded with the light bulb cover, and if there are impurities inside the light bulb cover, then performing lighting tests on the LED light bulb with the testing power supply.

11. The manufacturing method of claim 10, wherein in step S2, the hooks, the stepped portion, and the through holes through which the first wire and the second wire pass through are also formed with the transparent light bulb core during formation of the transparent light bulb core; in step S3, arranging the first wire and the second wire to pass through the through holes respectively so as to be fitted with the transparent light bulb core, then arranging the power board to be fitted on the stepped portion of the transparent light bulb core.

12. The manufacturing method of claim 11, wherein in step S6, the hooks hook onto the end of the mounting part when the transparent light bulb core obtained after step S5 is inserted and press-fitted into the mounting part of the light bulb cover.
